(19) United States
(12) Patent Application Publication
(10) Pub. No.: US 2013/0054021 A1
(43) Pub. Date: Feb. 28, 2013

(54) ROBOTIC CONTROLLER THAT REALIZES HUMAN-LIKE RESPONSES TO UNEXPECTED DISTURBANCES

(71) Applicants: AKIHIKO MURAI, Pittsburgh, PA (US); Katsu Yamane, O'Hara, PA (US)

(72) Inventors: AKIHIKO MURAI, Pittsburgh, PA (US); Katsu Yamane, O'Hara, PA (US)

(73) Assignee: DISNEY ENTERPRISES, INC., Burbank, CA (US)

(21) Appl. No.: 13/219,047

(22) Filed: Aug. 26, 2011

(51) Int. Cl. B25J 9/00; G06N 3/02

(52) U.S. Cl. 700/245; 901/23

(57) ABSTRACT

A robotic structure includes a component that moves from a first position to a second position. Further, the robotic apparatus includes a robotic controller that (i) receives an input quantity and an output quantity that are computed from human motion data based on a human musculoskeletal model, (ii) computes at least one parameter based on the input quantity and the output quantity, and (iii) outputs the output quantity to the component upon an input of robotic motion data from the component.

### BACKGROUND

1. Field

This disclosure generally relates to the field of robotics. More particularly, the disclosure relates to a robotic control system.

2. General Background

Safety concerns may arise from unexpected disturbances and environmental uncertainties of biped robots standing and walking in uncontrolled environments. For instance, in order to allow for freely moving humanoid robots in amusement and theme parks, a control strategy has to be implemented to ensure safety during interaction with guests. Most current control strategies involve controller selection or motion replanning according to the state change resulting from such disturbances.

As an example, many current humanoid robotic controls systems involve a set of controllers designed for different behaviors that have to be switched according to the estimated robot status. The humanoid robotic control system may activate a particular controller based on a behavior of the humanoid robot and switch to a different controller based on a different behavior of the humanoid robot. For example, a humanoid robot may have to recover from an external disturbance such as an external force. Current humanoid robotic control systems typically utilize a controller dedicated to balance recovery that assists the humanoid robot in recovering from the external disturbance. The control system may run a controller for nominal behavior such as standing or walking while monitoring the state of the humanoid robot. The control system invokes a recovery controller when disturbances are detected. For example, current systems may modify the center of mass trajectory to recover balance. Also, current systems may maximize a set of initial states that a controller can bring to a statically stable pose. Further, current systems may provide a single controller that can exhibit multiple strategies for balancing. In addition, current systems may also utilize controllers for recovering from large external forces or unexpected loads.

Other current control systems deal with external forces during locomotion. For example, current systems may utilize a set of fast online controllers along with offline pattern generation to handle disturbances. Further, current systems may utilize a controller to absorb the angular momentum generated by external forces by changing the foot placement.

However, the current systems involve disturbance detection, which is difficult to reliably perform in practice as a result of sensor noise and model uncertainties. For example, the controller dedicated to balance recovery may not provide balance recovery when a disturbance occurs as a result of inaccurate disturbance detection. Further, the current systems involve a controller that is invoked when disturbances occur or a set of controllers that is supposed to be designed in advance by modeling specific balance recovery behaviors. As a result, current humanoid robotic control systems are not robust.

Another possible source of disturbance is uncertainty in the environment. Current systems may involve a framework for locomotion control where the gait is replanned based on the estimated posture that may be different from the planned posture as a result of irregular terrains. However, the terrain change has to be relatively slow to allow replanning of the gait. Accordingly, current humanoid robotic control systems are not fast enough to adequately address environmental uncertainty disturbances.

### SUMMARY

In one aspect of the disclosure, a robotic apparatus is provided. The robotic apparatus includes a robotic structure that includes a component that moves from a first position to a second position. Further, the robotic apparatus includes a robotic controller that (i) receives an input quantity and an output quantity that are computed from human motion data based on a human musculoskeletal model, (ii) computes at least one parameter based on the input quantity and the output quantity, and (iii) outputs the output quantity to the component upon an input of robotic motion data from the component.

In another aspect of the disclosure, a system is provided. The system includes a human musculoskeletal model. Further, the system includes a robotic controller that (i) receives an input quantity and an output quantity that are computed from human motion data based on a human musculoskeletal model, (ii) computes at least one parameter based on the input quantity and the output quantity, and (iii) outputs the output quantity to a component of a robotic structure that moves from a first position to a second position upon an input of robotic motion data from the component.

In yet another aspect of the disclosure, a computer program product is provided. The computer program product includes a computer useable medium having a computer readable program. The computer readable program when executed on a computer causes the computer to receive an input quantity and an output quantity that are computed from human motion data based on a human musculoskeletal model. Further, the computer readable program when executed on the computer causes the computer to compute at least one parameter based on the input quantity and the output quantity. In addition, the computer readable program when executed on the computer causes the computer to output the output quantity to a component of a robotic structure that moves from a first position to a second position upon an input of robotic motion data from the component.

In another aspect of the disclosure, a robotic apparatus is provided. The robotic apparatus includes a robotic structure that includes a component that moves from a first position to a second position. Further, the robotic apparatus includes a robotic controller that (i) receives an input quantity and an output quantity that are computed from animal motion data based on an animal musculoskeletal model, (ii) computes at least one parameter based on the input quantity and the output quantity, and (iii) outputs the output quantity to the component upon an input of robotic motion data from the component.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a human neuromusculoskeletal system.

FIG. 2 illustrates a process that utilizes human motion data to determine the weight parameters of the neurons in the neuromuscular network model.

FIG. 3 illustrates a table that indicates the length of the nerve between each pair of muscle and vertebra if a connection exists between a muscle and vertebra.

FIG. 4 illustrates a set of neural network training graphs.

FIG. 5 illustrates a walking simulation that is calculated based upon the muscle tensions computed by the neuromuscular network model.

FIG. 6 illustrates a walking simulation of a trip response.

FIG. 7 illustrates a set of graphs illustrating the muscle tensions exerted by the neuromuscular network model for each row of the walking simulation illustrated in FIG. 6.

FIG. 8 illustrates a process that may be utilized to provide a human-like response to a disturbance of a robotic musculoskeletal structure.

FIG. 9 illustrates a block diagram of a station or system that provides a neuromuscular locomotion of a robotic apparatus.

### DETAILED DESCRIPTION

A robotic controller is provided. In one embodiment, the robotic controller receives an input quantity and an output quantity that are computed from human motion data based on a human musculoskeletal model. Further, the robotic controller computes at least one parameter based on the input quantity and the output quantity. In addition, the robotic controller outputs the output quantity to the component upon an input of robotic motion data from a component of a robotic structure. The component may be a robotic arm, a robotic leg, or the like. The component may be one of a plurality of components, e.g., a robotic arm selected from one or more robotic legs, a robotic leg selected from one or more robotic arms, or the like. In an alternative embodiment, the input quantity and the output quantity may be computed from animal motion data based on an animal musculoskeletal model.

In one embodiment, the robotic controller may be a neural network based upon a human anatomy with a time delay for nerve signal transmission. In yet another embodiment, the robotic controller may be a neural network with a time delay for nerve signal transmission. In another embodiment, the robotic controller may be a neural network without a time delay for nerve signal transmission. In yet another embodiment, the neural network may be a neural network that is a central pattern generator.

Further, in another embodiment the robotic apparatus may include at least one actuator that actuates movement of a component of the robotic structure based upon at least one muscle tension. The at least one actuator may be a muscle-type actuator, an electronic motor, or the like. In other words, the input quantity may be a muscle tension and an actuator such as a muscle-type actuator may actuate movement of a component based upon the muscle tension.

The input quantity may be a muscle length, muscle velocity, muscle tension, a contact force, or the like. Further, the output quantity may be a muscle tension or the like.

The at least one parameter may be a neuron weight in a neural network. The at least one parameter may be a constant. Alternatively, the at least one parameter may be a variable that is updated according to a learning configuration.

Although not limited to locomotion, as an example, the robotic controller may be a neuromuscular locomotion controller that outputs human-like responses to unexpected disturbances is provided. The neuromuscular locomotion controller may be based on an anatomical neural network that represents the human somatosensory reflex loop with time delay. Receiving the muscle lengths and tensions as inputs, the anatomical neural network outputs the muscle tensions at the next time step. The neural network parameters may be identified utilizing muscle length and tension data utilizing inverse kinematics and dynamics algorithms for a musculoskeletal human model. Accordingly, the neuromuscular locomotion controller is built on the human anatomical structure, and human motion data is utilized to simulate a human response to a disturbance. Further, trip recovery strategies emerge from the neuromuscular locomotion controller that are only learned from normal human locomotion data. As a result, the neuromuscular locomotion controller may be utilized to provide more robust control of biped robots by enabling rapid reaction to a disturbance.

The initial motion responses to unexpected disturbances in humans typically occur before sensory feedback involving the cerebellum can occur given the signal transmission delay in the human nerve system. An example of such initial motion responses in humans may be seen with respect to the unexpected disturbance of tripping as a result of an obstacle. Tripping involves a rapid response for recovery to prevent falling. For example, a human may elevate or lower himself or herself to avoid a fall depending on whether the trip occurred near the liftoff or the touchdown of the swing leg. Either response is clearly involuntary as such a response may be observed in less than one hundred milliseconds after the trip, which is shorter in duration than the time utilized to perform any feedback control involving the cerebellum.

As an example, the anatomical neural network may simulate human behavior after tripping. The neuromuscular locomotion controller of a robot may utilize that anatomical neural network to so that the musculoskeletal structure of the robot performs human-like motions in response to unexpected disturbances. Although the model is identified only from a walking motion, the two strategies for trip recovery, i.e., elevate or lower, emerge from a single controller. Accordingly, the neuromuscular locomotion controller provide rapid responses to trips without deliberate controller selection or motion replanning.

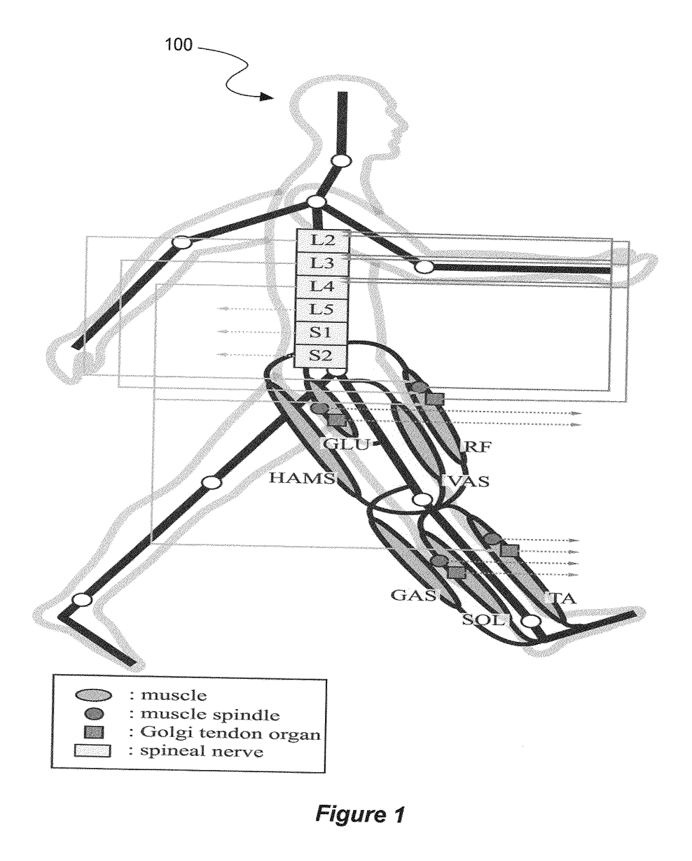

FIG. 1 illustrates a human neuromusculoskeletal system 100. The human neuromusculoskeletal system 100 includes a musculoskeletal model, physiological muscle model, proprioceptive receptor model, and neuromuscular network model. The musculoskeletal model is represented by a skeleton. The skeleton is simplified to a planar model in the sagittal plane with one rotational joint for each of the hip, knee and ankle joints. Accordingly, FIG. 1 only illustrates the major muscles relevant to the flexion/extension movements of these active joints. This simplification results in seven muscles for each leg: Hamstrings (“HAMS”), Gluteus Maximus (“GLU”), Tibialis Anterior (“TA”), Gastrocnemius (“GAS”), Rectus Femoris (“RF”), Vastus Lateralis (“VAS”), and Soleus (“SOL”). Each muscle is associated with a physiological muscle model that relates the muscle tension with the muscle activity, length, and its velocity by the following equation: fᵢ=−aᵢFₗ(lᵢ)Fᵥ(iᵢ)F_{max, i}. The variables fᵢ, aᵢ, lᵢ, iᵢ, and F_{max, l} represent the tension, activity, length, velocity, and maximum voluntary force of i-th muscle respectively. Further, the Fₗ(*) and Fᵥ(*) functions represent length-tension and velocity-tension relationship respectively. Further, a proprioceptive receptor model may be utilized to emulate the sensory information of the muscle spindles that detect the muscle length and its velocity in addition to the Golgi tendon organs that detect the muscle tension.

Accordingly, a neuromuscular network model of the anatomically-correct neuronal binding among the muscles, proprioceptive receptors, and the spinal nerves may be composed. The neuromuscular network model is a neural network with time delay for nerve signal transmission. Among the thirty-one vertebral columns, L2-L5, S1, and S2 are relevant to the muscles in the neuromuscular network model.

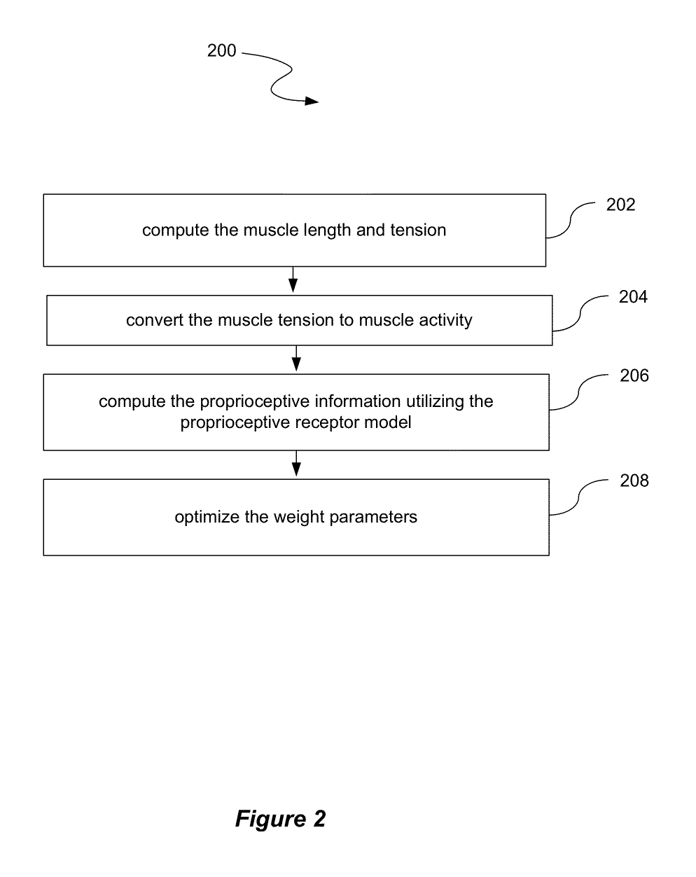

In one embodiment, the weight parameters of the neurons in the neuromuscular network model are unknown. FIG. 2 illustrates a process 200 that utilizes human motion data to determine the weight parameters of the neurons in the neuromuscular network model. At a process block 202, the process 200 computes the muscle length and tension. In one embodiment, this computation is performed by inverse kinematics and dynamics. However, other calculation methodologies may be utilized. Further, at a process block 204, the process 200 converts the muscle tension to muscle activity. In one embodiment, a physiological_muscle_model is utilized. In addition, at a process block 206, the process 200 may compute the proprioceptive information utilizing the proprioceptive receptor model. At a process block 208, the process 200 may optimize the weight parameters. As an example, a back-propagation methodology may be utilized to optimize the weight parameters.

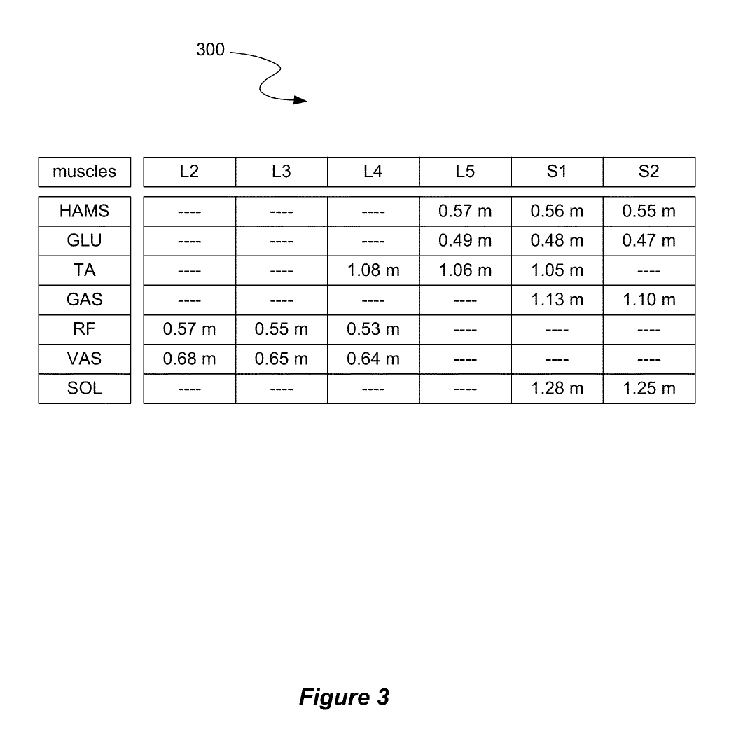

FIG. 3 illustrates a table 300 that indicates the length of the nerve between each pair of muscle and vertebra if a connection exists between a muscle and vertebra. For example, a connection does not exist between the HAMS muscle and the L4 vertebra. However, a connection exists between the HAMS muscle and the L5 vertebra, which is a length of 0.57 meters. The various illustrated lengths are measured in meters, but other measurements units may be utilized.

The neuromuscular locomotion controller may be utilized to simulate the human tripping response. With respect to the elevating strategy, if the trip happens at the early stage of the swing phase, the swing leg is lifted by activation of the Biceps Femoris muscle that occurs in a relatively short time frame after the trip, which results in a collision avoidance behavior. The early part of the swing stage may occur at approximately five percent to twenty five percent of the swing phase. With respect to the lowering strategy, if the trip happens later in the swing stage, the swing foot is lowered by the activation of the Rectus Femoris and the Soleus muscles in a relatively short time frame after the trip. These muscle activations result in an immediate contact of the swing leg with the ground. The later part of the swing stage may occur at approximately fifty five percent to seventy five percent of the swing phase. Either strategy may appear when the trip happens in the middle of the swing. The initial response appears as a change in the muscle tension pattern as early as 50 ms after the trip, which is much faster than any voluntary feedback involving the cerebellum. Therefore, a reasonable assumption is that no voluntary controller switching or planning occurs after a trip. Accordingly, the neuromuscular locomotion controller that has been utilized to generate the walking motion produces the trip response. The model parameters may be learned only from locomotion data determined in the muscle tensions and swing leg behavior during the period from 0 to 100 ms after the trip. A single neuromuscular locomotion controller may be able to rapidly respond to trips, which allows enough time for other controllers or replanning methodologies to take over. As a result, more robust locomotion control is realized.

The neuromuscular locomotion controller may be utilized to successfully reproduce trip responses. Walking and trip response involve the coordination of leg muscles. The neuromusculoskeletal system 100 illustrated in FIG. 1 may be utilized for the simulation and placement of an obstacle on a walk path so that a trip occurs at a desired time. Before the trip, a walking motion sequence is replayed and the inverse dynamics to estimate the muscle tensions is computed. When the swing leg hits the obstacle, the dynamics simulation using a dynamics simulator for humanoid robots may be initiated. In one embodiment, the neuromuscular network model is utilized as the controller to obtain the joint torques of the skeleton model. The neuromuscular network first computes the muscle activities at time t-t_{d} where t_{d} is the nerve signal transmission delay determined from the length of the nerves and other delays such as chemical reaction time in the synapse. The muscle activities are then converted to muscle tensions using a physiological muscle model and the current muscle lengths and their velocities. Finally, joint torques are computed from the muscle tensions using the Jacobian matrix of muscle length with respect to the joint angles. The joint accelerations computed by the simulator are integrated to obtain the state at the next time step.

In addition to the muscles illustrated in FIG. 1, several other elements are added to account for the elements unmodeled in the musculoskeletal model. Each joint in the upper body and arms is actuated by a proportional-derivative (“PD”) controller. Each of the knee joints receives additional spring-damper torque when the joint angle approaches the joint limit. A pair of weak spring and damper is attached to each ankle joint to model the passive elements around the joint because the passive torque has a strong effect on the joint motion as a result of the small mass and inertia.

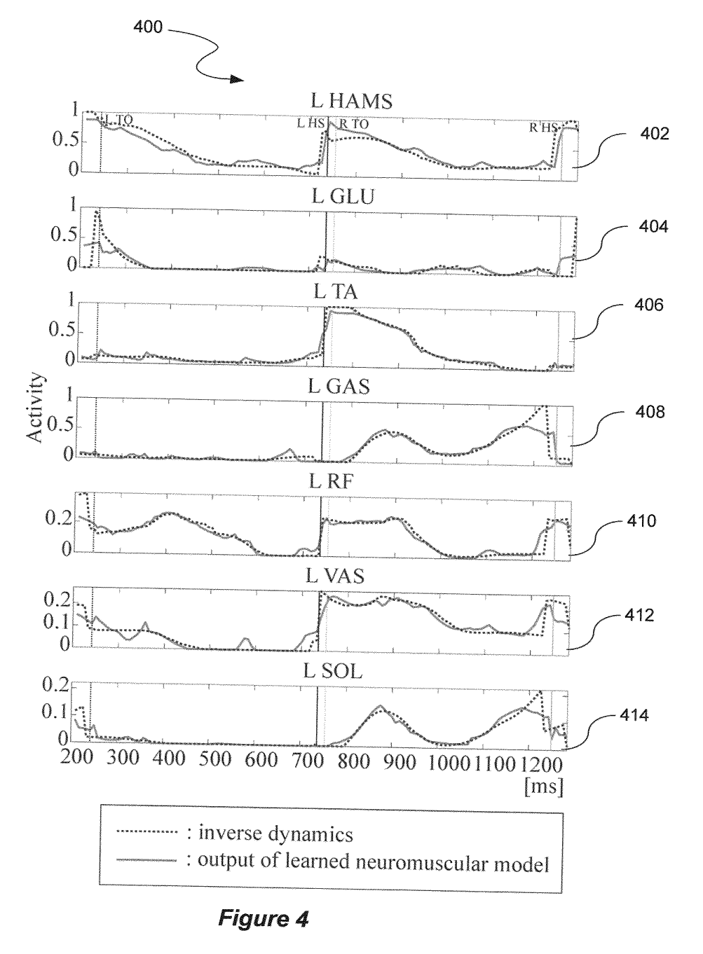

FIG. 4 illustrates a set of neural network training graphs. A motion capture system may be utilized to capture a walking motion sequence. The muscle activity obtained by dynamics computation and optimization, e.g., inverse dynamics computation, is illustrated by the dotted line and the output of the neural network model, e.g., identified neuromusculoskeletal system, is illustrated by the dashed line for each of the left leg muscles. The vertical axis represents the muscle activity and the horizontal axis represents time. An L HAMS graph 402 illustrates the muscles activity for the left HAMS, an L GLU graph 404 illustrates the muscle activity for the left GLU, an L TA graph 406 illustrates the muscle activity for the left TA, an L GAS graph 408 illustrates the muscle activity for the left GAS, an L RF graph 410 illustrates the muscle activity for the L RF, an L VAS graph 412 illustrates the muscle activity for the L VAS, and an L SOL graph 414 illustrates the muscle activity for the L SOL.

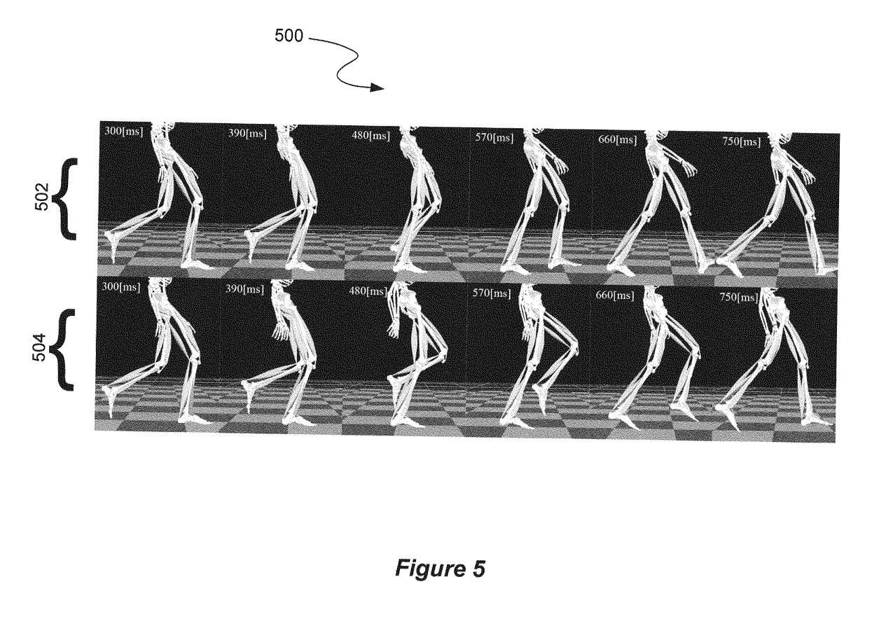

FIG. 5 illustrates a walking simulation 500 that is calculated based upon the muscle tensions computed by the neuromuscular network model. A top row 502 indicates normal walking motion utilized for the identification. Further, a bottom row 504 indicates a result of forward dynamics computation utilizing the identified neuromuscular network model. Small variations between the normal walking motion and the simulation may result from different contact conditions from the original motion capture data. For examples, the simulation utilizes bone geometry whereas the motion is captured with shoes. However, the simulated motion only has to be reasonably close to the original motion capture data.

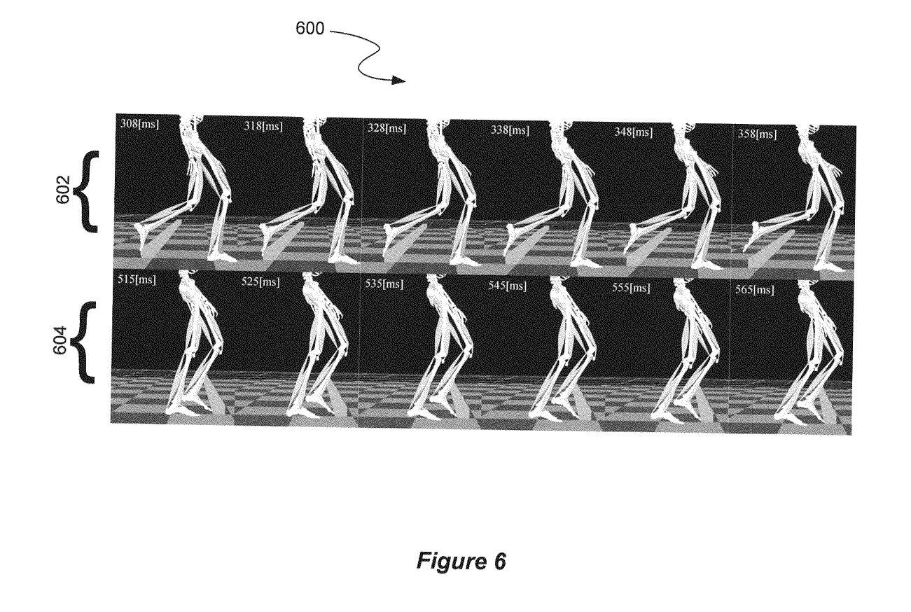

FIG. 6 illustrates a walking simulation 600 of a trip response. The timestamps begin at the start of the motion capture sequence. A top row 602 indicates a simulation involving a trip at an early part of the swing stage, e.g., thirteen percent of the swing at the timestamp of 308 ms of the left leg, which triggers an elevation of the left leg. The elevation of the left leg may be seen through the timestamp at 358 ms. The ankle plantar flexion and the knee flexion make the collision avoidance behavior of the swing leg. A bottom row 604 indicates a simulation involving a trip at a later part of the swing stage, e.g., fifty-six percent of the swing phase at timestamp 515 ms, which triggers a lowering strategy. The lowering of the left leg may be seen through the timestamp at 565 ms. The immediate contact of the swing leg with the ground may be observed. Accordingly, the trip simulation 600 indicates that the neuromuscular network can generate trip behaviors qualitatively similar to elevating and lowering strategies.

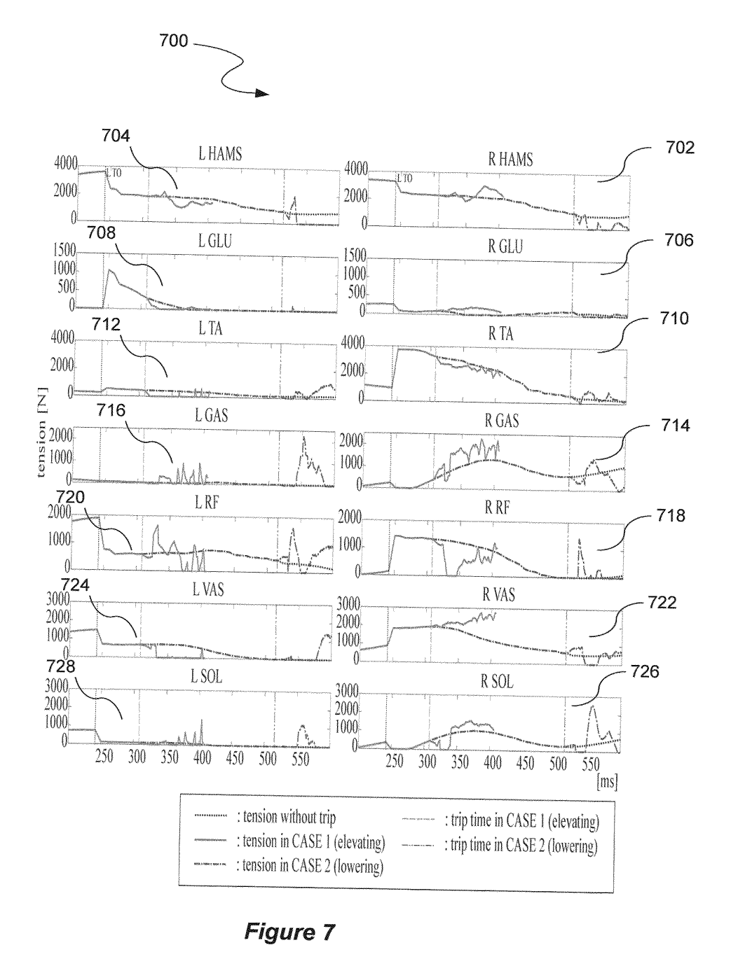

FIG. 7 illustrates a set of graphs illustrating the muscle tensions exerted by the neuromuscular network model for each row of the walking simulation 600 illustrated in FIG. 6. The top row 602 in FIG. 6 correlates to the first case in FIG. 7 and the bottom row 604 in FIG. 6 correlates to the second case in FIG. 7. An R HAMS graph 702 illustrates the muscle tensions exerted by the neuromuscular network model for the right HAMS, an L HAMS graph 704 illustrates the muscle tensions exerted by the neuromuscular network model for the left HAMS, an R GLU graph 706 illustrates the muscle tensions exerted by the neuromuscular network model for the right GLU, an L GLU graph 708 illustrates the muscle tensions exerted by the neuromuscular network model for the left GLU, an R TA graph 710 illustrates the muscle tensions exerted by the neuromuscular network model for the right TA, an L TA graph 712 illustrates the muscle tensions exerted by the neuromuscular network model for the left TA, an R GAS graph 714 illustrates the muscle tensions exerted by the neuromuscular network model for the right GAS, an L GAS graph 716 illustrates the muscle tensions exerted by the neuromuscular network model for the left GAS, an R RF graph 718 illustrates the muscle tensions exerted by the neuromuscular network model for the right RF, an L RF graph 720 illustrates the muscle tensions exerted by the neuromuscular network model for the left RF, an R VAS graph 722 illustrates the muscle tensions exerted by the neuromuscular network model for the right VAS, an L VAS graph 724 illustrates the muscle tensions exerted by the neuromuscular network model for the left VAS, an R SOL graph 726 illustrates the muscle tensions exerted by the neuromuscular network model for the right SOL, and an L SOL graph 728 illustrates the muscle tensions exerted by the neuromuscular network model for the left SOL. The dotted line represents tensions calculated from inverse dynamic computations for a trip. Further, the solid line represents elevation in the first case. In addition, the partially dashed line represents tension in the second case. FIG. 7 indicates that the simulated muscle activities match the elevating and lowering behaviors.

Accordingly, the neuromuscular network model can accurately reproduce the muscle tension patterns in the walking motion. In addition, despite the lack of reference trajectory and difference in the contact conditions, the motion simulated with muscle tensions from the neural network model is reasonably close to the original motion. From a robotics perspective, the neuromuscular locomotion controller designed for a normal behavior, e.g., locomotion, may be able to immediately respond to disturbances before relatively slow controller switching or motion replanning can take place. From a biomechanics perspective, the physiological observation that initial trip response occurs before any voluntary control can happen is produced.

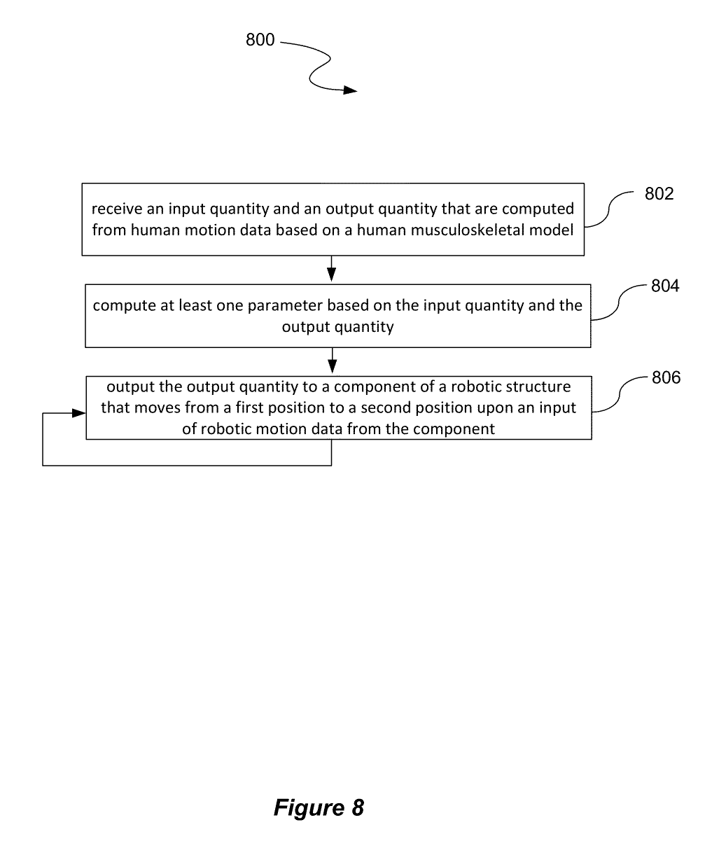

FIG. 8 illustrates a process 800 that may be utilized to provide an output to a component of a robotic structure. At a process block 802, the process 800 receives an input quantity and an output quantity that are computed from human motion data based on a human musculoskeletal model. Further, at a process block 804, the process 800 computes at least one parameter based on the input quantity and the output quantity. In addition, at a process block 806, the process 800 outputs the output quantity to a component of a robotic structure that moves from a first position to a second position upon an input of robotic motion data from the component. In one embodiment, the process 800 may move from the process block 806 back to the process block 806 and the process block 806 may be performed online. In another embodiment, although the process 800 may be performed in sequence according to the process block 802, the process block 804, and the process block 806, the process 800 may also be performed in a different sequence than illustrated in FIG. 8.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. For example, a computer may be a personal computer (“PC”), laptop, smartphone, tablet device, set top box, or the like.

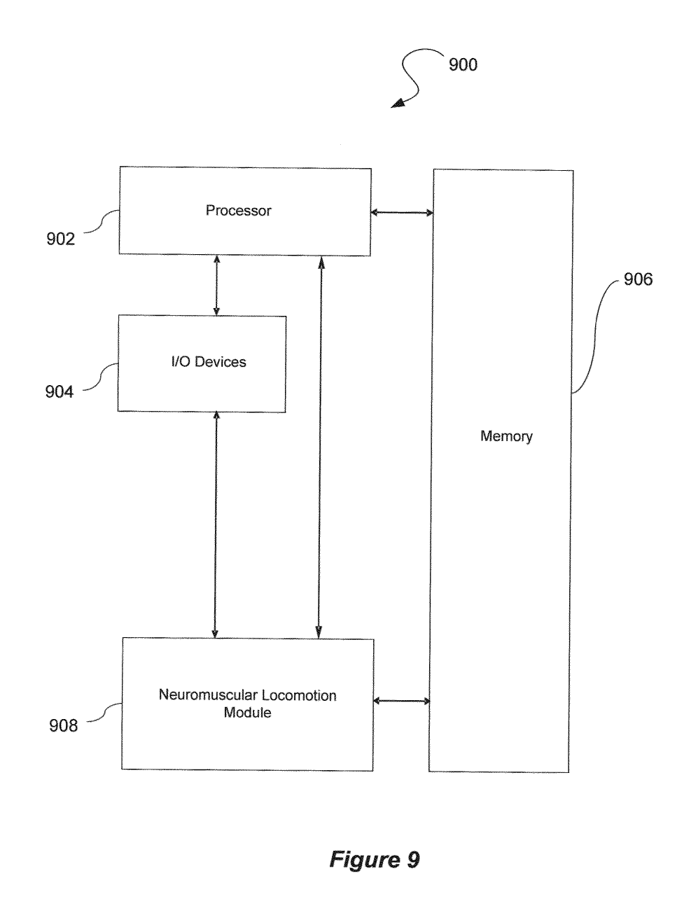

FIG. 9 illustrates a block diagram of a station or system 900 that provides an neuromuscular locomotion of a robotic apparatus. In one embodiment, the station or system 900 is implemented utilizing a general purpose computer or any other hardware equivalents. Thus, the station or system 900 comprises a processor 902, a memory 906, e.g., random access memory (“RAM”) and/or read only memory (ROM), a neuromuscular locomotion module 908, and various input/output devices 904, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the neuromuscular locomotion module 908 may be implemented as one or more physical devices that are coupled to the processor 902. For example, the neuromuscular locomotion module 908 may include a plurality of modules. Alternatively, the neuromuscular locomotion module 908 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 906 of the computer. As such, the neuromuscular locomotion module 908 (including associated data structures) of the present disclosure may be stored on a computer readable medium, e.g., RAM memory, magnetic or optical drive or diskette and the like.

The station or system 900 may be utilized to implement any of the configurations herein. For example, the processor 902 may be utilized to compose a neural network operate movement of a robotic device, perform computations, or the like. In another embodiment, the processor 902 is the neuromuscular locomotion controller, which may or may not utilize the neuromuscular locomotion module 908.

FIG. 9 provides an example of an implementation of a robotic controller. However, the robotic controller is not limited to neuromuscular locomotion and may be implemented with similar components of FIG. 9 to perform other types of output for a robotic apparatus.

It is understood that the apparatuses, systems, computer program products, and processes described herein may also be applied in other types of apparatuses, systems, computer program products, and processes. Those skilled in the art will appreciate that the various adaptations and modifications of the embodiments of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A robotic apparatus comprising:
a robotic structure that includes a component that moves from a first position to a second position; and
a robotic controller that (i) receives an input quantity and an output quantity that are computed from human motion data based on a human musculoskeletal model, (ii) computes at least one parameter based on the input quantity and the output quantity, and (iii) outputs the output quantity to the component upon an input of robotic motion data from the component.

2. The robotic apparatus of claim 1, wherein the component is a robotic leg.

3. The robotic apparatus of claim 1, wherein the component is a robotic arm.

4. The robotic apparatus of claim 1, wherein the robotic controller is a neural network based upon a human anatomy with a time delay for nerve signal transmission.

5. The robotic apparatus of claim 1, wherein the robotic controller is a neural network with a time delay for nerve signal transmission.

6. The robotic apparatus of claim 1, wherein the robotic controller is a neural network without a time delay for nerve signal transmission.

7. The robotic apparatus of claim 1, wherein the robotic controller is a neural network that is a central pattern generator.

8. The robotic apparatus of claim 1, further comprising at least one actuator that actuates movement of the component based upon at least one muscle tension.

9. The robotic apparatus of claim 8, wherein the at least one actuator is a muscle-type actuator.

10. The robotic apparatus of claim 8, wherein the at least one actuator is an electric motor.

11. The robotic apparatus of claim 1, wherein the input quantity is a muscle length.

12. The robotic apparatus of claim 1, wherein the input quantity is a muscle velocity.

13. The robotic apparatus of claim 1, wherein the input quantity is a muscle tension.

14. The robotic apparatus of claim 1, wherein the input quantity is a contact force.

15. The robotic apparatus of claim 1, wherein the output quantity is a muscle tension.

16. The robotic apparatus of claim 1, wherein the at least one parameter is a neuron weight in a neural network.

17. The robotic apparatus of claim 1, wherein the at least one parameter is a constant.

18. The robotic apparatus of claim 1, wherein the at least one parameter is updated according to a learning configuration.

19. A system comprising:
a human musculoskeletal model; and
a robotic controller that (i) receives an input quantity and an output quantity that are computed from human motion data based on a human musculoskeletal model, (ii) computes at least one parameter based on the input quantity and the output quantity, and (iii) outputs the output quantity to a component of a robotic structure that moves from a first position to a second position upon an input of robotic motion data from the component.

20. The system of claim 19, wherein the robotic controller is a neural network based upon a human anatomy with a time delay for nerve signal transmission.

21. The system of claim 19, wherein the robotic controller is a neural network with a time delay for nerve signal transmission.

22. The system of claim 19, wherein the robotic controller is a neural network without a time delay for nerve signal transmission.

23. The system of claim 19, wherein the robotic controller is a neural network that is a central pattern generator.

24. A computer program product comprising a computer useable medium having a computer readable program, wherein the computer readable program when executed on a computer causes the computer to:
receive an input quantity and an output quantity that are computed from human motion data based on a human musculoskeletal model;
compute at least one parameter based on the input quantity and the output quantity; and
output the output quantity to a component of a robotic structure that moves from a first position to a second position upon an input of robotic motion data from the component.

25. A robotic apparatus comprising:
a robotic structure that includes a component that moves from a first position to a second position; and
a robotic controller that (i) receives an input quantity and an output quantity that are computed from animal motion data based on an animal musculoskeletal model, (ii) computes at least one parameter based on the input quantity and the output quantity, and (iii) outputs the output quantity to the component upon an input of robotic motion data from the component.
